(19) United States
(12) Patent Application Publication
(10) Pub. No.: US 2006/0158047 A1
(43) Pub. Date: Jul. 20, 2006

(54) Non-reciprocal circuit device

(75) Inventors: Tsuyoshi Kinoshita, Tokyo (JP); Motoi Shimizu, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TDK Corporation, Tokyo (JP)

(21) Appl. No.: 11/300,491

(22) Filed: Dec. 15, 2005

(30) Foreign Application Priority Data
Dec. 16, 2004 (JP) 2004-364695

(51) Int. Cl. H02K 41/00

(52) U.S. Cl. 310/12

(57) ABSTRACT

A non-reciprocal circuit device is provided with a remarkably smaller size than before and can achieve higher performance if the outer shape is the same as before. A gyromagnetic component, a permanent magnet, a first yoke and a second yoke are included. The permanent magnet is provided at least on one face side of the gyromagnetic component and applies a DC magnetic field to the gyromagnetic component. The first and second yokes constitute a magnetic path for the magnetic field generated by the permanent magnet, have face plate portions and rise portions rising from the face plate portions, and the end faces of the rise portions are opposed to each other.

### BACKGROUND OF THE INVENTION

1. Field of the Invention

The present invention relates to a non-reciprocal circuit device, such as an isolator or a circulator.

2. Description of Related Art

Non-reciprocal circuit devices such as isolators or circulators are used in mobile wireless equipments such as cellular phones. This type of non-reciprocal circuit device is constituted by, as represented by JP-A-11-205011 and JP-A-11-97910, accommodating magnetic parts such as a gyromagnetic component constituted by a soft magnetic substrate, a central electrode, etc. and electric parts such as a matching capacitor, a terminating resistor and so on in a magnetic metal casing serving as a yoke.

The yoke is used as a means for improving magnetic efficiency of a DC magnetic field applied to the gyromagnetic component, but in addition to this original role, the core structural portion such as the gyromagnetic component and the permanent magnet is used also as a means for secured joining in general. In concrete, such a structure is adopted that the yoke is comprised by a first yoke constituting a part of a magnetic metal case and a second yoke used as a lid body of the magnetic metal yoke, and the second yoke is placed over the outside of the magnetic metal case so as to be joined with the first yoke.

This type of non-reciprocal circuit device is faced with demand for miniaturization as much as possible from its marketability, and as a means for responding to the demand is, as disclosed in the JP-A-11-205011 and JP-A-11-97910, for example, a structure in which a square-shaped soft magnetic substrate is used instead of a circular soft magnetic substrate and this is accommodated in a case having a square-shaped inner space for accommodating a capacitor, a terminating resistor, etc. with high density utilizing the space between the soft magnetic substrate and the inner wall surface of the case.

However, even if the structure as disclosed in JP-A-11-205011 and JP-A-11-97910 is adopted, because of the structure that the second yoke is placed over the outside of the magnetic metal case constituting the first yoke, the second yoke is forced to swell out on both side faces of the magnetic metal case by its depth. Therefore, the miniaturization has been limited.

### SUMMARY OF THE INVENTION

An object of the present invention is to provide a non-reciprocal circuit device with a remarkably smaller size than before.

Another object of the present invention is to provide a non-reciprocal circuit device which can achieve higher performance if the outer shape is the same as before.

In order to solve the above problem, the non-reciprocal circuit device according to the present invention comprises a gyromagnetic component, a permanent magnet, a first yoke and a second yoke. The permanent magnet is provided at least on one face side of the gyromagnetic component and applies a DC magnetic field to the gyromagnetic component. The first and second yokes are arranged so as to surround the permanent magnet and the gyromagnetic component and provide a magnetic path for the permanent magnet. Each of the first and second yokes has a face plate portion and a rise portion rising from the face plate. The end face of the rise portion of the first yoke and the end face of the rise portion of the second yoke are opposed to each other.

As mentioned above, by providing the permanent magnet on one face side of the gyromagnetic component so that the DC magnetic field is applied to the gyromagnetic component and a magnetic path is constituted with respect to the permanent magnet through surrounding of the permanent magnet and the gyromagnetic component by each of the first yoke and said second yoke, magnetic efficiency of the permanent magnet to the DC magnetic field is improved and a structure to sufficiently exert the characteristics of the gyromagnetic component is realized.

In this structure, since each of the first and second yokes has a face plate portion and a rise portion rising from the face plate portion, and the end face of the rise portion of the first yoke and the end face of the rise portion of the second yoke are opposed to each other, the outer face of the second yoke and the outer face of the first yoke can be placed on the substantially continuous same face. Unlike the conventional structure that the second yoke is placed over the outside of the magnetic metal case constituting the first yoke, the second yoke does not expand by its thickness on both side faces of the magnetic metal case. Therefore, further miniaturization becomes possible. With the same outer shape as before, the shape of the gyromagnetic component and the permanent magnet can be enlarged so as to achieve higher performance.

As a preferred embodiment, each of the first and second yokes has a protruded and recessed surface on the end face of the rise portion to provide protrusion and recess fitting. According to this structure, in addition to the above-mentioned benefit of miniaturization, the nesting fitting structure that the other rise portion enters the face of one rise portion in the zigzag state can be obtained so as to improve magnetic efficiency as compared with the flat-surface abutment structure.

The first yoke may be used as a part of the magnetic metal case as before. Alternatively, different from the above, the first yoke may be constructed without a concept of a case only by bending a magnetic plate material.

As mentioned above, according to the present invention, a non-reciprocal circuit device with a remarkably smaller size than before can be provided.

### BRIEF DESCRIPTION OF THE DRAWINGS

FIG. 1 is an exploded perspective view showing a preferred embodiment of a non-reciprocal circuit device according to the present invention.

FIG. 2 is a perspective view of the non-reciprocal circuit device shown in FIG. 1 in the assembled state.

FIG. 3 is a perspective view of a gyromagnetic component.

FIG. 4 is an exploded perspective view showing another preferred embodiment of the non-reciprocal circuit device according to the present invention.

FIG. 5 is a perspective view of the non-reciprocal circuit device shown in FIG. 4 in the assembled state.

FIG. 6 is a perspective view showing another preferred embodiment of the non-reciprocal circuit device according to the present invention.

FIG. 7 is an exploded perspective view showing another preferred embodiment of the non-reciprocal circuit device according to the present invention.

FIG. 8 is a perspective view showing the non-reciprocal circuit device shown in FIG. 7 in the assembled state.

FIG. 9 is a perspective view showing parts arrangement.

FIG. 10 is an exploded perspective view showing still another preferred embodiment of the non-reciprocal circuit device according to the present invention.

FIG. 11 is an exploded perspective view showing still another preferred embodiment of the non-reciprocal circuit device according to the present invention.

### DETAILED DESCRIPTION OF THE PREFERRED EMBODIMENTS

Other purposes, constitution and advantages of the present invention will be described in more detail referring to the attached drawings. However, the attached drawings are shown only for illustrating purpose.

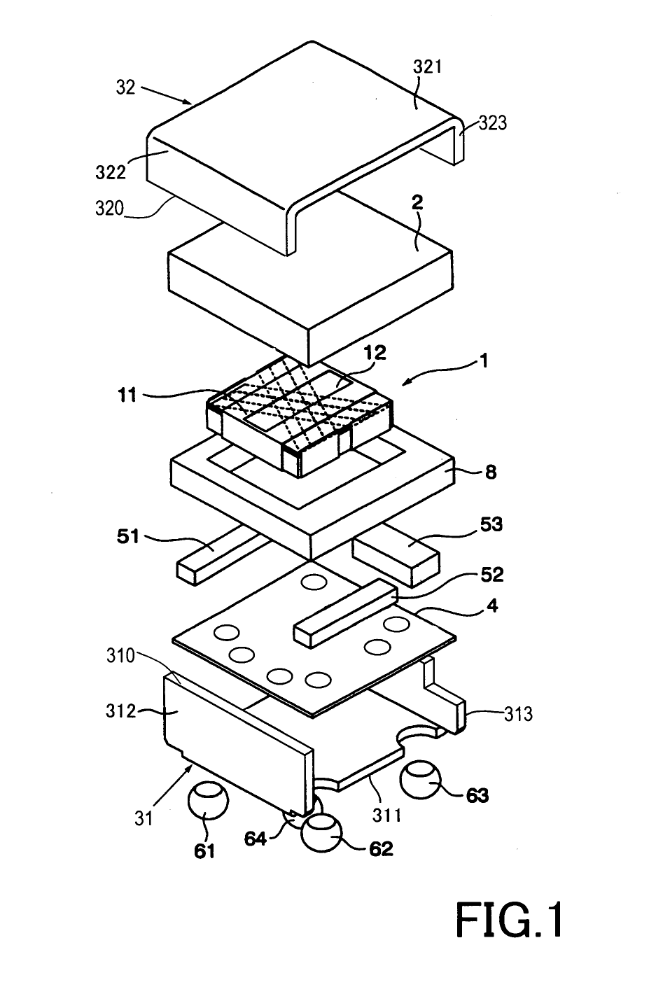

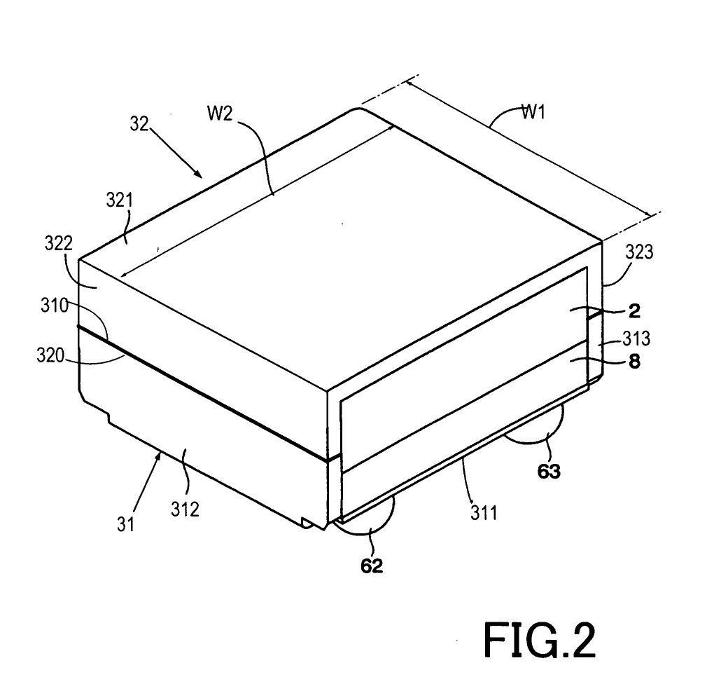

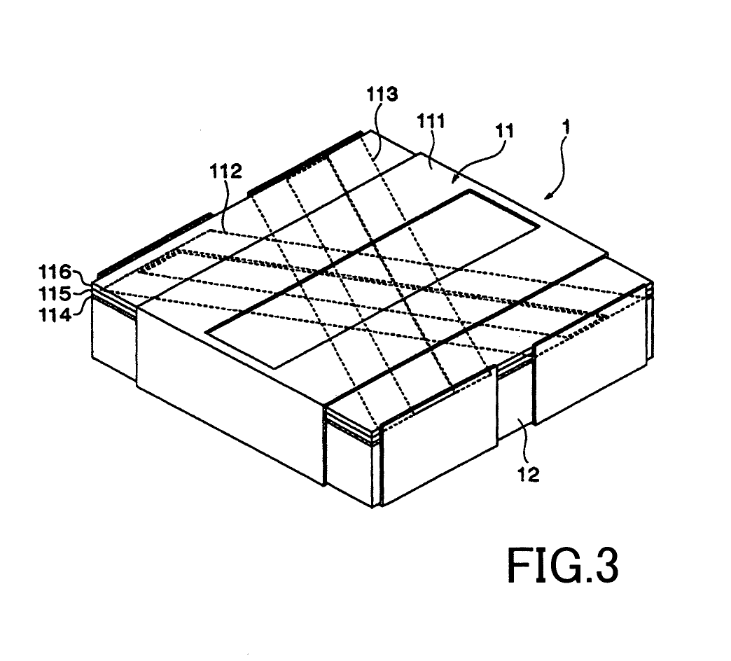

FIG. 1 is an exploded perspective view showing a preferred embodiment of a non-reciprocal circuit device according to the present invention, FIG. 2 is a perspective view of the non-reciprocal circuit device shown in FIG. 1 in the assembled state, and FIG. 3 is a perspective view of a gyromagnetic component. These Figs. show an example of an isolator.

The illustrated non-reciprocal circuit device has a gyromagnetic component 1, a permanent magnet 2, a first yoke 31, and a second yoke 32 as its indispensable constituting portions. In the preferred embodiment, it further has a supporting substrate 4, capacitors 51, 52, a terminating resistor 53, and a plurality of metal balls 61 to 64 to be input/output terminals and ground terminals.

The gyromagnetic component 1 includes, as shown in FIG. 3, a central electrode 11 and a soft magnetic substrate 12. The central electrode 11 includes first to third center conductors 111 to 113. The first to third center conductors 111 to 113 are branched from 3 sides of an approximately square-shaped ground portion in contact with the lower surface of the soft magnetic substrate 12. The first to third center conductors 111 to 113 are provided through insulating bodies 115, 116, respectively, so that they cross each other on the main surface of the soft magnetic substrate 12 at a predetermined angle. The third center conductor 113 located on the lowermost side is formed on an insulating body 114 provided on the soft magnetic substrate 12.

As the soft magnetic substrate 12, a soft magnetic material (ferrite) such as yttrium/iron/garnet (YIG) is preferable. The shape of the soft magnetic substrate is not limited, but it is preferably a square.

The permanent magnet 2 is to apply a DC magnetic field to the gyromagnetic component 1 and is provided on one face side of the gyromagnetic component in the preferred embodiment. However, it may be provided on both faces of the gyromagnetic component 1.

The first yoke 31 and the second yoke 32 constitute a magnetic path with respect to the magnetic field generated by the permanent magnet 2. It is needless to say that the first yoke 31 and the second yoke 32 are made of a magnetic material. The first yoke 31 and the second yoke 32 in the preferred embodiment are made by bending processing of a magnetic metal plate. The first yoke 31 and the second yoke 32 are combined with each other so that they surround the permanent magnet 2 and the gyromagnetic component 1.

In each of the first yoke 31 and the second yoke 32, end faces of rise portions (312, 313) (322, 323) are opposed to each other. That is, an end face 310 of the rise portion 312 in the first yoke 31 is opposed to an end face 320 of the rise portion 322 in the second yoke 32, and the end face 310 of the rise portion 313 in the first yoke 31 is opposed to the end face 320 of the rise portion 323 in the second yoke 32. The end faces 310, 320 may be in close contact with each other or may be separated from each other to some extent. Also, a slight displacement in the plate thickness direction may be generated. Moreover, a border portion generated between the end faces 310-320 may be joined by an electrically conductive adhesive. The electrically conductive adhesive may be given magnetism.

As mentioned above, by providing the permanent magnet 2 on one face side of the gyromagnetic component 1 so that the DC magnetic field is applied to the gyromagnetic component 1 and a magnetic path is constituted with respect to the permanent magnet 2 through surrounding of the permanent magnet 2 and the gyromagnetic component 1 with each of the first yoke 31 and said second yoke 32, magnetic efficiency of the permanent magnet 2 to the DC magnetic field is improved and a structure to sufficiently exert the characteristics of the gyromagnetic component 1 is realized. The gyromagnetic component 1 and the permanent magnet 2 are received by the face plate portions 311, 321 of the first yoke 31 and the second yoke 32, respectively, and held stably.

In this structure, in each of the first yoke 31 and the second yoke 32, since the end faces 310, 320 of the rise portions (312, 313), (322, 323) are opposed to each other, the outer face of the second yoke 32 and the outer face of the first yoke 31 can be placed on the substantially continuous same surface. Unlike the conventional structure that the second yoke is placed over the outside of the magnetic metal case constituting the first yoke, the second yoke does not swell out by its thickness on both side faces of the magnetic metal case. Therefore, further miniaturization becomes possible. With the same outer shape as before, the shape of the gyromagnetic component 1 and the permanent magnet 2 can be enlarged so as to achieve higher performance.

Next, another structure shown in FIGS. 1 to 3 and its technical significance will be described, though they are not the direct subject matter of the present invention. First, the permanent magnet 2 has both opposing side faces exposed to both opposing side faces of the non-reciprocal circuit device so as to determine a width dimension W1 of the entire non-reciprocal circuit device. A case is not provided. According to this structure, miniaturization is possible without being restricted by the case.

The first yoke 31 and the second yoke 32 are led through the side faces different from the both side faces to which the side faces of the permanent magnet 2 are exposed, that is, the side faces in the length direction. According to the present invention, in each of the first yoke 31 and the second yoke 32, since the end faces 310, 320 of the rise portions (312, 313), (322, 323) are opposed to each other, increase in dimension by overlapping of yokes need not be considered, and since a dimension W1 in the length direction is reduced, remarkable miniaturization becomes possible as a whole.

The illustrated non-reciprocal circuit device further includes a supporting substrate 4, has the gyromagnetic component 1 and the permanent magnet 2 loaded on one face of the supporting substrate 4 and restricts the entire structure by the first yoke 31 and the second yoke 32. According to this structure, a predetermined characteristic can be obtained by assuredly restricting the permanent magnet 2, the gyromagnetic component 1 and the supporting substrate 4 in a predetermined positional relation in the structure not having a case.

The outer shape of the gyromagnetic component 1 shown in the preferred embodiment is smaller than the permanent magnet 2. If the outer shape of the gyromagnetic component 1 is smaller than the permanent magnet 2, a space is generated between the gyromagnetic component 1 and the permanent magnet 2 due to the outer shape difference. This space is preferably filled by an insulating resin 8. By this, reliability is improved.

Moreover, in the preferred embodiment, the outer shape of the supporting substrate 4 is matched with the permanent magnet 2. The supporting substrate 4 has almost the same outer shape as that of the permanent magnet 2, and when the gyromagnetic component 1 is disposed above the supporting substrate 4, a space is generated between the outer circumference of the gyromagnetic component 1 and the outer circumference of the supporting substrate 4 due to the outer shape difference between the both. The capacitors 51, 52 and the terminating resistor 53 are disposed in the above space and fixed to the conductor pattern formed on the supporting substrate 4 by soldering or the like and also fixed to a predetermined one of the center conductors 111 to 113 by means of soldering or the like so as to have a known circuit configuration. And the periphery is filled with the insulating resin 8. As shown in FIG. 1, the entire space need not be filled but only the exposed face may be filled with the insulating resin 8.

On the supporting substrate 4, an appropriate electrode is further formed, and metal balls 6 to be input/output terminals and ground terminals are mounted using the electrode and conductor pattern. To the metal balls 6, the center conductors 111 to 113, capacitors 51, 52 and terminating resistor 53 are connected to have a predetermined electric circuit.

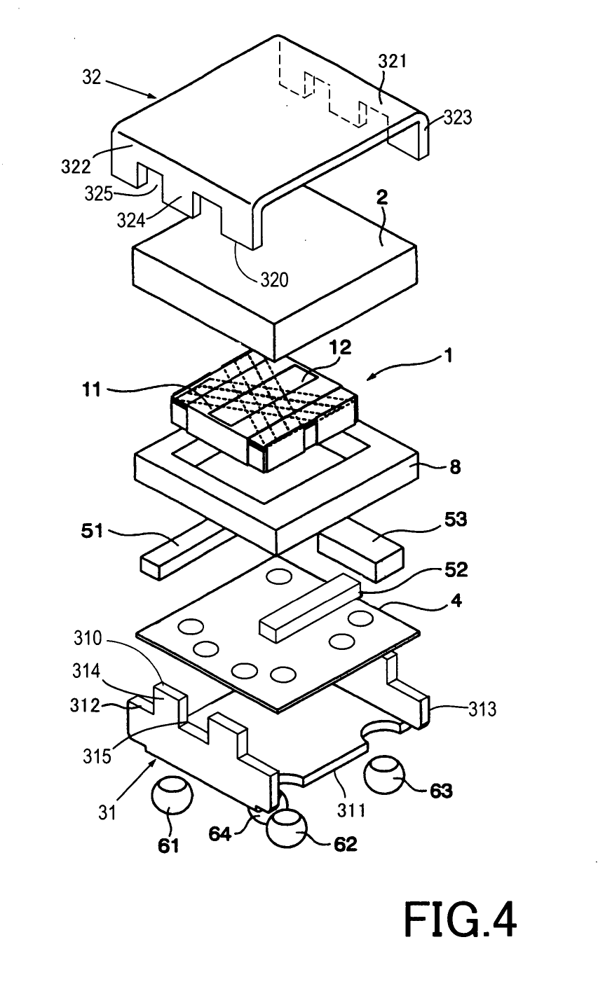

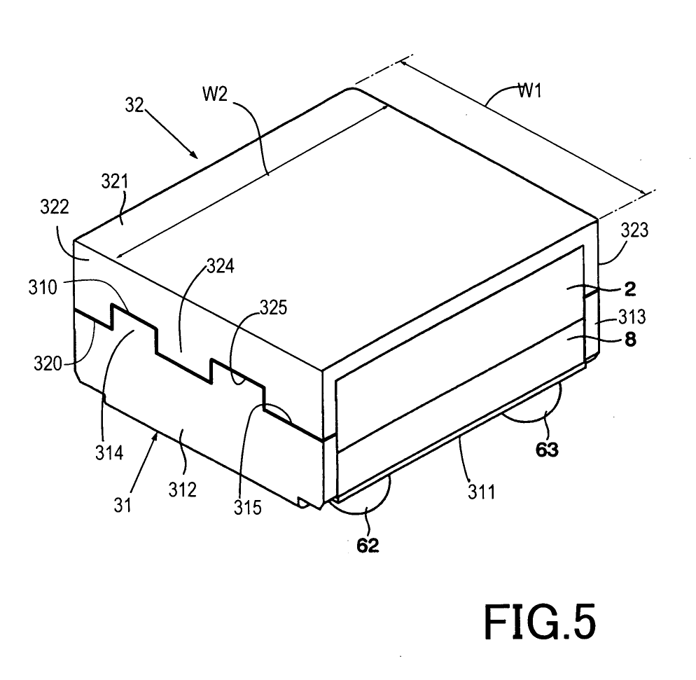

FIG. 4 is an exploded perspective view showing another preferred embodiment of the non-reciprocal circuit device according to the present invention, and FIG. 5 is a perspective view of the non-reciprocal circuit device shown in FIG. 4 in the assembled state. In this Fig., the same reference numerals are given to the portions corresponding to structural portions appeared on FIGS. 1 to 3 so as to omit duplicated description.

The characteristic point of the illustrated non-reciprocal circuit device is that the end faces 310, 320 of the rise portions (312, 313), (322, 323) are protruded and recessed faces in each of the first yoke 31 and the second yoke 32, the protruded and recessed faces are made to abut to each other and joined by the protrusion and recess fitting.

In the illustrated preferred embodiment, as a concrete structure of the protrusion and recess fitting, a protruded portion 314 and a recess portion 315 are provided on end edges of the rise portions 312, 313 rising along the both opposing sides of the face plate portion 311 of the first yoke 31. On the other hand, a protruded portion 324 and a recess portion 325 are provided on end edges of the rise portions 322, 323 provided along both opposing sides of the face plate portion 321 of the second yoke 32.

And the rise portion 312 of the first yoke 31 and the rise portion 322 of the second yoke 32, and the rise portion 313 of the first yoke 31 and the rise portion 323 of the second yoke 32 are made to abut to each other, and the protruded portions 314 provided on the rise portions 312, 313 of the first yoke 31 are fitted in the recess portions 325 provided on the rise portions 322, 323 of the second yoke 32. Moreover, in the recess portions 315 provided on the rise portions 312, 313 of the first yoke 31, the protruded portions 324 provided on the rise portions 322, 323 of the second yoke 32 are fitted. The border portions generated by the fitting may be joined by an electrically conductive adhesive. Magnetism may be applied to the electrically conductive adhesive.

In this preferred embodiment, too, the outer face of the second yoke 32 and the outer face of the first yoke 31 can be placed on the substantially continuous same face. Unlike the conventional structure that the second yoke 32 is placed over outside the magnetic metal case constituting the first yoke 31, the second yoke 23 does not swell out by its thickness on both side faces of the magnetic metal case. Therefore, further miniaturization is enabled. With the same outer shape as before, the shape of the gyromagnetic component 1 and the permanent magnet 2 can be made larger so as to achieve higher performance.

Moreover, the protruded portions 314 provided on the rise portions 312, 313 of the first yoke 31 are fitted in the recess portions 325 provided on the rise portions 322, 323 of the second yoke 32, and the protruded portions 324 provided on the rise portions 322, 323 of the second yoke 32 are fitted in the recess portions 315 provided on the rise portions 312, 313 of the first yoke 31, and that results in the nesting fitting structure in which the other rise portions 322, 323 enter the faces of one rise portions 312, 313 in the zigzag manner. According to this structure, magnetic efficiency can be improved as compared with the flat-face abutment structure.

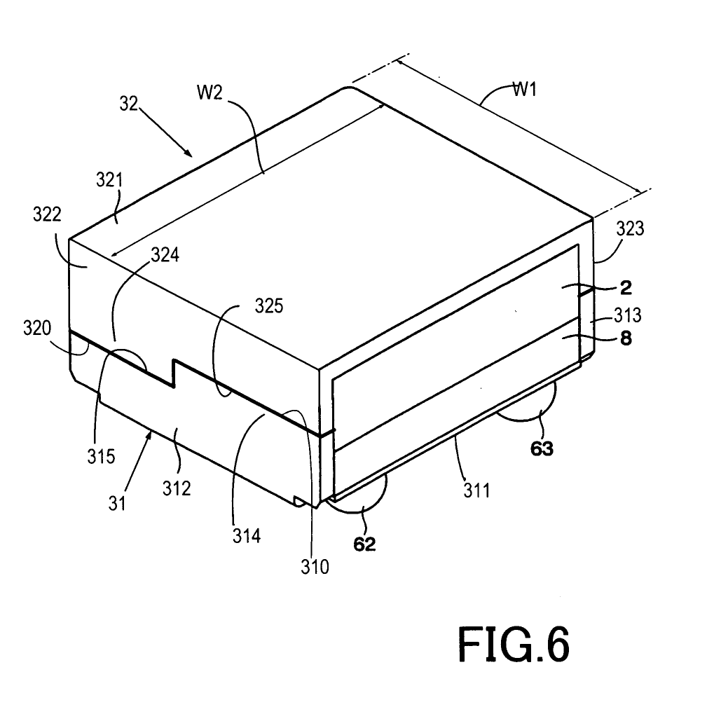

FIG. 6 is a perspective view of the non-reciprocal circuit device according to the present invention in the assembled state. In Fig., the same reference numerals are given to the portions corresponding to structural portions appearing on FIGS. 1 to 3 so as to omit duplicated description.

In this preferred embodiment, one protruded portion 314 and one recess portion 315 are provided on the rise portions 312, 313 of the first yoke 31, and one protruded portion 324 and one recess portion 325 are also provided on the rise portions 322, 323 of the second yoke 32. And the protruded portions 324 provided on the rise portions 322, 323 of the second yoke 32 are fitted in the recess portions 315 of the rise portions 312, 313 of the first yoke 31, and the protruded portions 324 provided on the rise portions 322, 323 of the second yoke 32 are fitted in the recess portions 315 provided on the rise portions 312, 313 of the first yoke 31. By this structure, too, magnetic efficiency can be improved as compared with the flat-face abutment structure. Though illustration is omitted, the number of the recess portions 315, 325 corresponding to the protruded portions 314, 324 is arbitrary, and it is needless to say that the number can be increased from that illustrated.

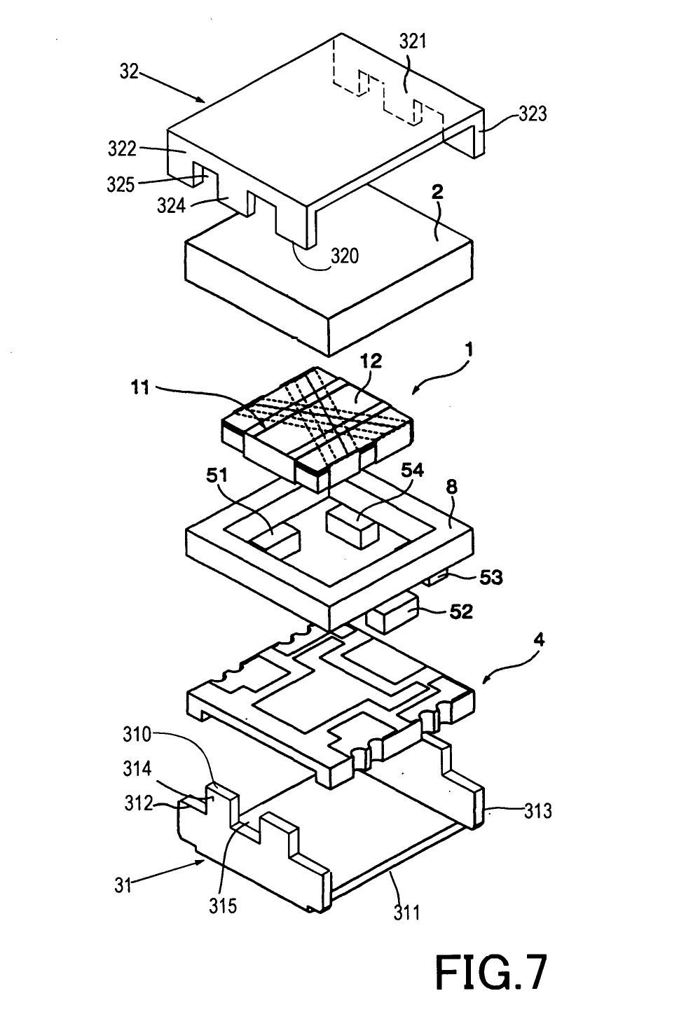

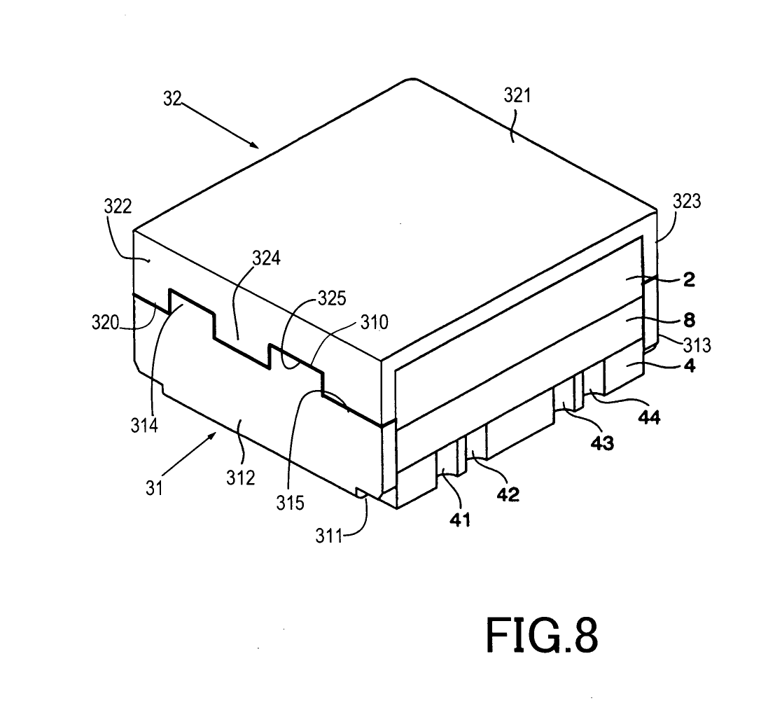

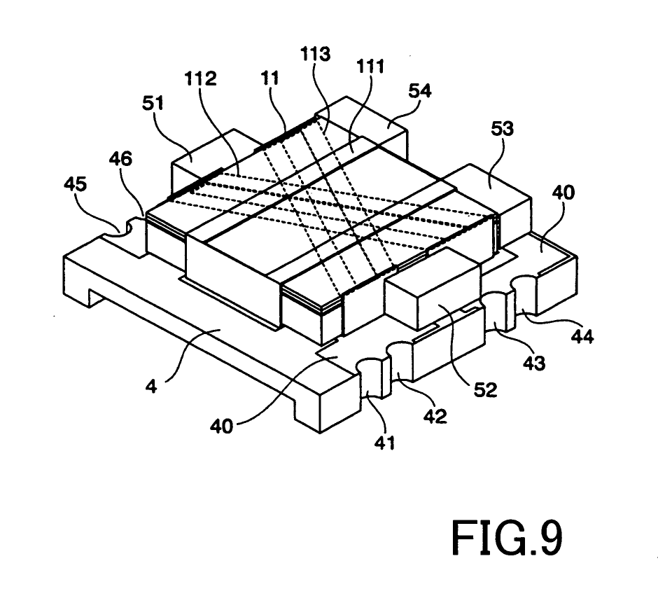

FIG. 7 is an exploded perspective view showing a preferred embodiment of the non-reciprocal circuit device according to the present invention, FIG. 8 is a perspective view of the non-reciprocal circuit device shown in FIG. 7 in the assembled state, and FIG. 9 is a perspective view showing parts arrangement. This preferred embodiment also shows an example of an isolator. In the Figs., the same reference numerals are given to the portions corresponding to structural portions appearing on FIGS. 1 to 3 so as to omit duplicated description. The difference from the preferred embodiment shown in FIGS. 1 to 3 is the difference in structure of the supporting substrate 4. That is, in the preferred embodiment shown in FIGS. 7 to 9, the supporting substrate 4 has a conductor pattern 40 formed on one face in a predetermined pattern for connecting the capacitors 51, 52, terminating resistors 53, 53 and the center conductors 111 to 113. Also, recess grooves 41 to 46 or the like are provided on the side face of the supporting substrate 4, and a conductor film continuing to the conductor pattern 40 is applied inside the recess grooves 41 to 46. Among the recess grooves 41 to 46, the recess grooves 41, 42 are used as input terminals, the recess groves 43, 44 as ground terminals and the recess grooves 45, 46 as output terminals, for example.

In this preferred embodiment, too, each of the first yoke 31 and the second yoke 32 has face plate portions 311, 321 and rise portions (312, 313), (322, 323) rising from the face plate portions 311, 321, and the end portions of the rise portions (312, 313), (322, 323) are made to abut to each other and joined by the protrusion and recess fitting. Therefore, this preferred embodiment also exerts the same working effect as the preferred embodiment shown in FIGS. 1 to 3.

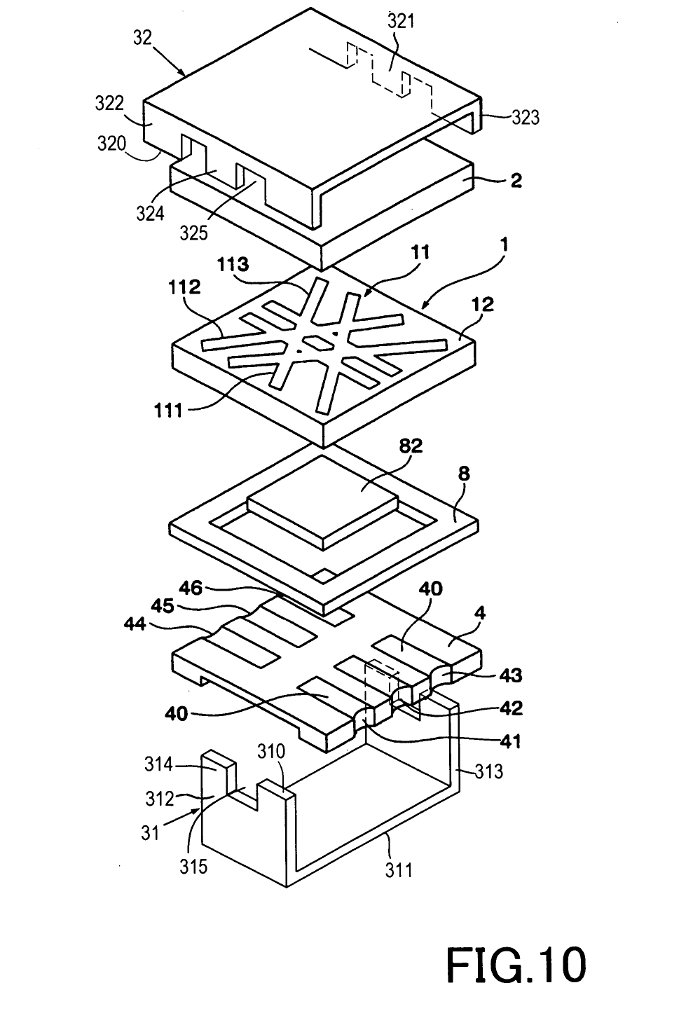

FIG. 10 is an exploded perspective view showing a preferred embodiment of the non-reciprocal circuit device according to the present invention. In this Fig., the same reference numerals are given to the portions corresponding to structural portions appearing on FIGS. 1 to 9 so as to omit duplicated description. He characteristic of the preferred embodiment shown in FIG. 10 is configuration of the gyromagnetic component 1. That is, the gyromagnetic component 1 has the central electrode 11 formed as a conductor film on one face of the soft magnetic substrate 12. The center conductors 111 to 113 constituting the central electrode 11 are insulated from each other by an inorganic or organic insulating film and formed on one face of the soft magnetic substrate 12. For derivation of the center conductors 111 to 113, the through-hole technology or the like can be applied.

The gyromagnetic component 1 is joined to the supporting substrate 4 through a functional substrate 82 including a capacitor and a terminating resistor required for circuit configuration. At that time, as mentioned above, a space may be filled with an adhesive resin 8. It is not necessary to fill all the spaces but only the exposed face may be filled with the insulating resin 8. Also, the above-mentioned insulating resin 8 may have an adhesive function. In this case, the fixation strength between components such as the permanent magnet 2, supporting substrate 4, gyromagnetic component 1 or the like can be increased.

Since each of the first yoke 31 and the second yoke 32 has the end face portions 311, 321 and the rise portions (312, 313), (322, 323) rising from the end face portions 311, 321, and the ends of the rise portions (312, 313) (322, 323) are made to abut to each other and joined to each other by protrusion and recess fitting, the same working effect as the that of the preferred embodiment shown in FIGS. 1 to 3 can be obtained.

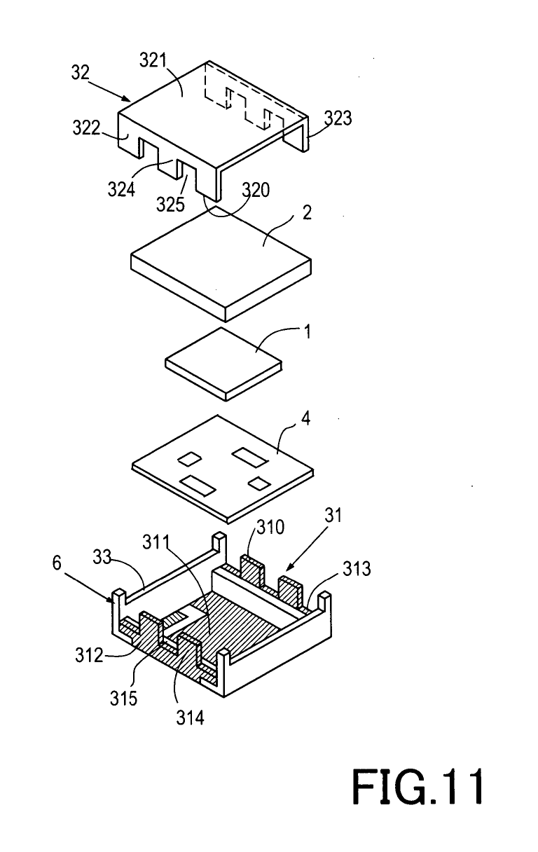

The preferred embodiments in FIGS. 1 to 10 have been explained by referring to the case not having casing as an example, but the present application can be also applied to the case having casing. The example is shown in FIG. 11.

In FIG. 11, a case 6 has a structure in which the first yoke 31 is integrated to an insulating body 33 made of a synthetic resin. Such a structure can be realized by so-called insert molding. The first yoke 31 has the rise portions 312, 323 rising from the face plate portion 311. The second yoke 32 has, as with the preferred embodiments shown in FIGS. 1 to 10, the face plate portion 321 and the rise portions 322, 323 rising from the face plate portion 321. In the first yoke 31 constituting a part of the case 6 and the second yoke 32, the ends of the rise portions (312, 313) (322, 323) are made to abut to each other and joined by the protrusion and recess fitting. Therefore, with regard to the protrusion and recess fitting, the same working effect as that of the above described preferred embodiments can be exerted.

Though illustration is omitted, the protruded portions and the recessed portions can take the structure as shown in FIGS. 1 to 3 and 5 in the preferred embodiments shown in FIGS. 7 to 11, too. Also, it is needless to say that the number of the protrusion and recess fittings is not limited to that illustrated.

The present invention has been described above in detail referring to the preferred embodiments, but the present invention is not limited to them but it is obvious that those skilled in the art can come up with various variations based on the basic technical idea and instructions.

What is claimed is:

1. A non-reciprocal circuit device comprising a gyromagnetic component, a permanent magnet, a first yoke and a second yoke, wherein:
said permanent magnet is provided at least on one face side of said gyromagnetic component and applies a DC magnetic field to said gyromagnetic component; and
said first and second yokes are arranged so as to surround said permanent magnet and said gyromagnetic component and provide a magnetic path for said permanent magnet, each of said first and second yokes has a face plate portion and a rise portion rising from said face plate portion, the end face of said rise portion of said first yoke and the end face of said rise portion of said second yoke are opposed to each other.

2. A non-reciprocal circuit device in claim 1, wherein each of said first and second yokes has a protruded and recessed face on the end face of the rise portion to provide protrusion and recess fitting.

3. A non-reciprocal circuit device in claim 1, wherein said permanent magnet has two opposite side faces that form part of the exterior face.

4. A non-reciprocal circuit device in claim 2, wherein said permanent magnet has two opposite side faces that form part of the exterior face.

5. A non-reciprocal circuit device in claim 3, wherein said rise portions of said first and second yokes pass side faces different from said two opposite side faces of said permanent magnet.

6. A non-reciprocal circuit device in claim 4, wherein said rise portions of said first and second yokes pass side faces different from said two opposite side faces of said permanent magnet.

7. A non-reciprocal circuit device in claim 1, wherein said gyromagnetic component has the outer shape smaller than said permanent magnet, and the space between said gyromagnetic component and said permanent magnet generated by said outer-shape difference is filled with an insulating resin.

8. A non-reciprocal circuit device in claim 2, wherein said gyromagnetic component has the outer shape smaller than said permanent magnet, and the space between said gyromagnetic component and said permanent magnet generated by said outer-shape difference is filled with an insulating resin.

9. A non-reciprocal circuit device in claim 3, wherein said gyromagnetic component has the outer shape smaller than said permanent magnet, and the space between said gyromagnetic component and said permanent magnet generated by said outer-shape difference is filled with an insulating resin.

10. A non-reciprocal circuit device in claim 4, wherein said gyromagnetic component has the outer shape smaller than said permanent magnet, and the space between said gyromagnetic component and said permanent magnet generated by said outer-shape difference is filled with an insulating resin.

11. A non-reciprocal circuit device in claim 5, wherein said gyromagnetic component has the outer shape smaller than said permanent magnet, and the space between said gyromagnetic component and said permanent magnet generated by said outer-shape difference is filled with an insulating resin.

12. A non-reciprocal circuit device in claim 6, wherein said gyromagnetic component has the outer shape smaller than said permanent magnet, and the space between said gyromagnetic component and said permanent magnet generated by said outer-shape difference is filled with an insulating resin.
